(19) United States
(12) Patent Application Publication
(10) Pub. No.: US 2009/0119209 A1
(43) Pub. Date: May 7, 2009

(54) MOBILE TRANSACTION NETWORK

(76) Inventors: Chris Sorensen, Sunnyvale, CA (US); Kenneth Donald Kruszka, San Francisco, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/260,946

(22) Filed: Oct. 29, 2008

Related U.S. Application Data
(60) Provisional application No. 60/984,917, filed on Nov. 2, 2007.

(51) Int. Cl. G06Q 20/00

(52) U.S. Cl. 705/40

(57) ABSTRACT

A financial transaction processing system and network that supports multiple types of financial and other transactions which may be initiated or confirmed using a mobile device, internet or telephone. The system employs one or more centralized host processors which connect to one or more clearing banks, and to a network of various other partners which may include custodian banks and other service providers such as merchants. The host processor acts as a communications switch validating incoming transaction requests from users and routing them to the appropriate partners for execution. The central processor maintains user records that can be queried by the partner processors. The financial network provides accessibility, speed and finality of settlement in transactions by using several settlement methods including the use of correspondent bank accounts held at the clearing banks or other interbank settlement methods such as the ACH.

### CROSS-REFERENCE TO RELATED APPLICATION

The present application claims priority of provisional application 60/984,917, filed Nov. 2, 2007.

### BACKGROUND OF THE INVENTION

This invention relates to financial systems and, in particular, to an international data processing network which provides accessibility, speed, and flexibility in effecting payments 24 hours a day in and among multiple national currencies, in particular, through the use of mobile phones.

In general, users deposit or transfer cash into an account at a custodial institution (e.g. bank, credit union, prepaid debit card, etc).

The custodian may keep the account value in US dollars or a foreign currency, or even shares of gold (or other precious assets and derivative securities, gold futures, ETF's etc). The custodian credits the user's account with the value of the deposit after it is exchanged into the currency or security type the user desires.

At this point, in the case of non-cash holdings, the user becomes a shareholder. The value of the asset is determined by the market place and is available to the user on demand through system access points including the user's mobile phone and internet.

The international financial community today operates using numerous national currencies and with them, distinct systems, rules, procedures and laws for currency payments for settlements of obligations within the country issuing that currency. Most rely on the country's central bank, such as the Federal Reserve in the United States, to guarantee that once a payment is made, it is irreversible. The timing of this guarantee, which is called finality of payment, varies by country and by system and may be immediate, at the close of the business day, sometime the following business day, or much later. This guarantee, and the execution of transactions, is dependent upon the operating hours of the central bank and, typically, the system over which the transactions flow. Thus, there exist within the financial community acute problems and risks when making payments in a particular country when the transfer of the underlying currency of the transaction is not supported by that country's financial system and its central bank.

Furthermore, this fragmentation of financial systems hinders the ability to change the value of the wealth held in one national currency into another national currency. The foreign exchange market is used for this purpose, but carries with it certain costs, delays in money availability and risk. In addition, there are similar problems when moving money within a national currency such as moving U.S. Dollars through the Federal Reserve Bank's Fedwire system, an internal mechanism within the Federal Reserve system to transfer currency which provides immediate finality of payment.

Fedwire encompasses several Federal Reserve Bank districts, located in different geographical areas of the country, each with operational jurisdiction over its node of the Fedwire system. Moving money from a bank in one Federal Reserve district to a bank in another Federal Reserve district utilizing Fedwire may be subject to delay because it must pass through several intermediate Fedwire district nodes. Moreover, the transactions are conducted via the Federal Reserve wire which has at critical times failed. A noteworthy example of a failure(s) of the Federal Reserve wire occurred during the October 1987 stock market collapse.

This shortcoming is not limited to the United States. Other networks exist, not necessarily Government sponsored, for foreign currencies such as the CHAPS system for transfers of Pounds Sterling.

To date, there are no systems in effect or proposed which allow a user to use a mobile phone or the internet to move funds from one custodian or bank to another, potentially involving different currencies or different asset classes, with instant and guaranteed settlement and notification, with no repudiation.

An example of delays and costs associated with currency transactions is a simple foreign exchange transaction, such as from U.S. Dollars to Mexican Pesos. A user typically wishing to make such an exchange currently requires the intervention of at least two banks, a bank in the United States to initiate the transfer in dollars and a receiving bank or a currency exchange agent in Mexico to convert the funds into Pesos. Multi-day delays for fund availability are common even in the case of wire transfers. The requirement that multiple banks be used may increase fees.

Furthermore, since the two sides of the transaction are not executed within the same financial management system, there is an opportunity for loss, or errors. For example if one side of the transaction is accomplished but the associated companion transaction is not. Thus, there exists a need within the financial community for a vehicle by which currency transactions and exchanges can be made on a timely, reliable and synchronous basis.

Although it is known to use mobile devices for financial transactions, such uses are generally limited to the user being able to use the phone to transfer money between a single user and single accounts associated with that user.

### SUMMARY OF THE INVENTION

The system alleviates these problems of currency infungibility and the dependence on a central bank for payment movement and payment finality. Additionally, international remittances and payments are subject to the operating procedures of each bank involved in the process, which may delay availability of funds and introduce additional costs.

Given these problems with existing financial systems, the invention provides a global network which allows users to use their mobile phones to instantly send money to any other mobile phone in the world. Also provided is an international financial transaction network which permits foreign exchange transactions to be executed irrespective of the types of currencies involved, as well as permitting the purchase and transfer of shares of securities such as shares of stock or gold managed across multiple custodians.

The invented financial transaction processing system and network supports multiple types of financial and other transactions which may be initiated or confirmed using a mobile device, internet or telephone. The transaction processing network is designed to:
a) associate a particular account with a particular phone number. The user may also have multiple accounts associated with their phone number—e.g Checking, savings, debit card, mortgage account, bill pay accounts, etc. The system can route transactions to/from the various accounts based on user instructions. See multiple account example below.
(b) in response to receiving a request to approve and initiate a transaction associated with the account, approve and route the request to the appropriate processing partner,
(c) coordinate a funds transfer between the clearing banks and the custodian banks,
(d) as required, automatically transmit a message to the account holder via the phone number,
(e) as required, request that the account holder confirm that the transaction is valid and
(f) use a response to the message to determine whether to approve or deny the transaction.

The system employs one or more centralized host processors which connect to one or more clearing banks, and to a network of various other partners which may include custodian banks and other service providers such as merchants. The host processor acts as a communications switch validating incoming transaction requests from users and routing them to the appropriate partners for execution. The central processor maintains user records that can be queried by the partner processors. The financial network provides accessibility, speed and finality of settlement in transactions by using several settlement methods including the use of correspondent bank accounts held at the clearing banks or other interbank settlement methods such as the ACH.

The system maintains records on a centrally managed network database in which relationships among various user accounts are maintained.

A user may hold funds in any currency maintained by the network partner custodians or may hold assets in other financial instruments such as shares of stock or gold as supported by the user's financial custodian. For example a user may hold three different currency denominated accounts held at three different custodians in U.S. Dollars, Japanese Yen and British Pounds. The user is able to transfer and exchange funds between any of his own accounts, or another user's accounts regardless of denomination. The transfer of funds between single or multiple currencies can be made from the account of one user to that of another user even if those accounts are held by different custodians or in different asset types. In one form of the invention the value transfer can be executed by a central clearing bank or custodian, at which both the sending and receiving custodians hold clearing accounts. In this scenario, the sending custodian is the bank of one user and the receiving custodian is the bank of a second user, both of which hold correspondent accounts at the central clearing bank.

The invented system operates by instructing the central clearing bank or custodian to debit the account it holds for the sending custodian and credit the account it holds for the receiving custodian. The receiving custodian sets the foreign exchange rate, if required, and notifies the system of the recipient's new balance in the appropriate currency.

In the case of assets held in different currencies, or held in financial instruments other than currency (e.g. shares of stock or gold), a user may move assets from one account to another by redeeming shares held in the first account and depositing the proceeds into the second account. The recipient determines in what currency or asset they would like their account held, and the proceeds from transfer can be used to purchase the specified asset type. Allowable assets types are determined by each custodian. Alternatively the recipient may choose to hold the asset in its original form and not to convert to the asset type held by his custodian bank. In this case the system will open a new account for the recipient at the sender's custodian to hold the asset type. For example a Mexican recipient is sent a transfer in US dollars; the recipient may wish to continue to hold US Dollars and not have the funds converted into Mexican Pesos. In this case the recipient can instruct the system to hold US dollars for him at a US custodian bank which may be either the sender's custodian bank, the central clearing bank, or another bank as determined by the system.

Access to the financial network would be, generally, utilizing an access point such as a mobile phone, potentially using SMS messaging, Interactive Voice Response (IVR) dedicated software or an internet connection to provide access into the system.

The present invention provides mobile platform interoperability between multiple (N) financial institution custodians and other value adding partners. This platform is a “plug and play” platform that creates an N to N network of partners so that any partner (bank, advertiser, etc) can interact with any user (consumer) regardless of with which custodian the user has an account or in what form the assets are held.

### DESCRIPTION OF THE DRAWINGS

FIG. 1 is an overall system diagram illustrating the overall flow of transaction information according to the invention.

FIG. 2 illustrates the various components which utilize the invented system.

FIG. 3 illustrates network routing between various users of the system.

FIG. 4 illustrates the registration process for a new user.

FIG. 5 illustrates the processing of a user's transaction request.

FIG. 6 illustrates an application/WAP which works with the invented system.

FIG. 7 illustrates a balance change notification example according to the invention.

FIG. 8 illustrates the invented system using a clearing bank model.

FIG. 9 illustrates the invented system using a network correspondent model.

### DETAILED DESCRIPTION OF THE INVENTION

The invention is directed to a mobile transaction network (MTN) which operates as an independent clearinghouse designed to facilitate and accelerate the growth of mobile financial transactions.

Access to a financial network is achieved through an access point which may include the internet or a mobile phone which may use either SMS text messaging, mobile internet, a dedicated mobile application or IVR interface. The ability to format and transmit instructions, receive confirmations from the host system, and make inquiries is provided from the user access point.

In the case of using a dedicated mobile software application, a menu driven interface with multiple levels of security, formatted screens for data input, and local editing capability is provided for the mobile phone. The specifics of such dedicated software are not important for a proper understanding of the invention, and would be well within the abilities of a person skilled in the art utilizing the information provided herein.

The central processor of the financial network invokes security routines to ensure authorized access to the system and acts to validate, accept or reject, and route all transactions to their appropriate destinations. Additionally, account information, confirmations and status messages are sent to users.

The transaction management system performs administrative tasks, such as assigning transaction numbers to instructions, holding transactions in a pending queue awaiting acknowledgement of further information to complete the transaction and performing additional functions within the financial network. The system may use fault tolerant computer technology. A variety of computer technologies are possible.

A secure communication link is established between the Transaction Management System and the central clearing custodian, partner custodians and other partners.

This invention employs multiple custodians which may be located at different international locations. It will be understood that an alternative to a central global clearing custodian is a network of multiple custodians each with specified settlement methods. The custodian(s) maintains custody of the user's assets including those located outside the United States.

Certain elements of each process flow are common to all types of transactions. The user will access the financial network through an access point, and enter appropriate passwords that denote an authorized user. Instructions will be entered and edited via a mobile phone using text messaging, a dedicated menu driven software application provided for the mobile phone or internet. A communications link is established with the system in order to transmit those instructions.

The user enters the required data for a particular transaction type into the access device. For the purposes of his own tracking, the user can also assign a unique transaction description which remains with the transaction throughout the flow.

For all transactions, the system reviews the instructions received from the user and checks for syntax error (in the case of SMS messages) and content validity. For some transactions, the system also checks for a sufficient funds balance by inquiry to the appropriate custodian's database. If for any reason the transaction is not valid, it will be rejected and the system will issue an appropriate error message to the user. An audit trail of all accepted and rejected transactions is kept for each user who was party to the transaction.

When a transaction has been received the system assigns a transaction number to it. This transaction number generated by the system is separate from the user's description. The transaction will then be time-stamped and tagged that it has been accepted or rejected. Notification of an accepted transaction will be sent to the user, thus indicating that the transaction has been executed.

Transactions that are put into a pending queue, e.g. those that are dependent on receipt of “good funds”, for example, are checked periodically to see if they meet the criteria for execution. With regard to certain transactions, the user is notified at the end of a specified period that required events have not occurred, and after a further specified period the transaction will be deleted, and a message will be sent to the user's mobile phone.

When a custodian receives a transaction request from the system, it executes the transaction and updates the user's account records as required. The custodian notifies the system that the transaction is complete, and system time-stamps and tags the transaction as completed.

### How the Mobile Transaction Network Operates

One form of the invention includes a central clearing bank which holds correspondent accounts for the benefit of international custodian banks that in turn hold user accounts. The correspondent accounts can all be held in a single currency (e.g., US dollars) while the user accounts can be held in local currencies or some other financial instrument that the custodian supports such as shares of stock, bonds, or shares of a commodity such as gold or other precious metal.

In order to move value from one user account to another (e.g. payment, purchases or remittances) the user can use a cell phone to send instructions to the system (either directly, or through a third party mobile payments partner connected to the system). The instructions are encoded into a system transaction and routed to the appropriate custodian bank for approval and execution.

The use of a central clearing bank makes it is possible to execute an international cross currency transfer, without the funds having to physically move into or out of the central clearing bank. When the transaction is approved by all participating custodians, the system instructs the central clearing bank to debit the correspondent account of the sender's bank and credit the correspondent account of the recipient's bank.

The invented system notifies both the sender's and the recipient's custodian banks that their correspondent accounts at the central clearing bank have been adjusted in US dollars. Both banks then update their respective user accounts based on the daily foreign exchange rate as required. Thus a value transfer transaction only requires balanced accounting entries at the clearing bank executed in a single currency (e.g. US dollars), regardless of the currencies or asset type held by either the sender or recipient.

Alternatively, a central clearing bank is not required. The network operator may initiate settlement credit agreements with partner custodians or place funds on deposit in a correspondent account at each of the custodian banks in the network to in order to provide the good funds required to conduct an instant and guaranteed transaction.

Certain custodians, such as brokerages, allow users to hold assets in financial instruments other than currency such as shares of stock, bonds, gold or other precious metals and their related derivatives. The ability to hold non currency denominated assets may be attractive to users in developing countries who face extreme fluctuations in currency value and inflation and who may wish to hold their assets in a more desirable form at an international custodian. Users can transfer assets to other users who can choose to accept the transfer in its original form or currency or alternatively, recipients can specify that they only wish to hold a specified currency or asset type supported by their custodian.

If the recipient wishes to maintain the asset in its original form or currency, and their custodian does not support the asset type, a new account can be created for them at the appropriate custodian of the user's choice.

Otherwise the system will convert the transferred asset into the currency or asset form of the user's choice at the daily price which is determined by the receiving custodian and is available to the user through any of the systems access points including the user's mobile phone and internet.

### Major Functions

The invented mobile transaction network provides three critical functions: Access, Routing, Clearing and Settlement. Network participants can include banks, brokerages, debit card issuers, carriers, mobile virtual network operators, merchants, application developers, and providers of other financial services such as loans and mortgages.

### Access

End users can avail themselves of the services provided through the mobile transaction network by way of a number of access points. Access points include, but are not limited to: short message service (SMS), wireless application protocol (WAP), mobile web, dedicated mobile phone-resident applications, interactive voice response (IVR), the internet, and through other open-access platforms.

The power of the network is enhanced by also providing access to users of third party mobile financial service providers. By connecting third party providers to the invented mobile transaction network users of both systems can interact with each other which increases the value to all users.

### Routing

Similar to how a credit card transaction is routed from a merchant's terminal to an issuing bank for authorization and processing, the invention routes mobile payments, remittances and other transactions from the sender's source account (e.g. bank account, credit card, debit card, etc) to the recipient's account. Both the originating and receiving custodians have a direct connection to the invented system, and so do not need to have a direct connection to each other.

A database maintained by the system stores each user's phone number and a proxy ID that points to the user's account at his custodian or third party processor, i.e., the electronic systems used by a bank to maintain its users' accounts. The system can also use a proxy (or nickname) for a recipient 's phone number (e.g. “Mom”) and instantiate the actual phone number in the background—so the user's do not have to remember the recipient's phone number if they have provided a nickname.

When a transaction is sent through the network, the system first checks to see if the sender and recipient phone numbers are both known users, then routes the transaction to both the sender's and recipient's custodian processors for acceptance and execution. If the recipient is not registered with the system, the system can send an SMS message to invite the recipient to open an account with a custodian who is a participant in the network in order to allow the transaction to be completed.

### Clearing and Settlement

The invented system can facilitate instant, guaranteed mobile payments between users. Once a transaction is authorized and accepted by all participating custodians, the recipient is given access to the funds. Clearing and settlement can be handled in multiple ways depending on which is most appropriate for each custodian. One form of the invention uses a correspondent banking structure where partner custodians hold clearing accounts at the central clearing bank. The central clearing bank executes transfer transactions by debiting and crediting the respective clearing accounts it holds for each custodian. This design allows mobile transactions to be settled instantly between custodians that hold accounts at the central clearing bank.

For custodian partners who do not wish to hold correspondent accounts at the clearing bank, other settlement mechanisms can be used. In some cases the network operator may choose to place funds in a correspondent account with the recipient's custodian. The recipient custodian debit's the network operator's correspondent account and credit's the recipient's account, thereby allowing the recipient instant access to the transferred funds. The network operator replenishes its correspondent account as required (net of inflows and outflows) using traditional interbank settlement methods (e.g. ACH, SWIFT, etc).

For transactions between custodians where one or both have neither a correspondent account with the central clearing bank, nor hold a correspondent account for the network operator the system will initiate settlement using traditional interbank methods such as SWIFT, CHAPS, FedWire, ACH, and other such traditional means of bank-to-bank money movement. In this case the transaction will not be instant or guaranteed. The time lapse for availability or funds, and associated risks for the recipient, will be determined by which settlement method is used between the custodian banks.

### Operational Details

Users are registered with the system in a variety of ways, primarily:
a) Users register themselves with a network participant to use their services (e.g. bank, mobile payment provider, loyalty point provider, bill payment service, merchant, etc). The network participant uploads the customer's registration data (e.g. name, address, phone number, ID information, and a unique proxy ID) to the system's database.
b) Users may also register directly with the system themselves using a variety of methods (SMS, web, WAP, mobile application, IVR, internet, live agent, etc).
c) User data is acquired from a third party and uploaded into the system.

There are three types of ways to initiate a transaction (or message) as follows:
1) Using any of the various access points, users can initiate several types of transactions such as:
   a) Purchase, Payment, or personal remittance
   b) Information Request (Balance, transaction history, opt-in, opt-out, etc.)
   c) System commands (e.g. “Help,” “Send,” “Borrow,” etc.)
   d) Bill presentment and payment
   e) Request for money or payment
2) Participating organizations can initiate a wide variety of transactions and messages such as:
   a) Account alerts and messages
   b) Offers and promotions
   c) Gifts and rebates
   d) Requests for information or preferences
3) The system can initiate or forward a variety of transactions and messages such as:
   a) Confirmation requests for transaction or accounts
   b) Transaction receipts
   c) Offers and promotions
   d) Alerts and error messages
   e) Reports and system status
   f) Administrative and technical reports

An example of a user initiated transaction is as follows:
a) User initiates a transaction at an access point.
b) The transaction may be sent through a partner system or directly to the network.
c) The network authenticates the user with a variety of methods (personal identification number (PIN), password, phone number, biometric, voice print, digital certificate, IVR, etc).
d) The system identifies the custodian who owns the account (this may be packaged with the incoming transaction or it may be retrieved from the system's database).
e) The system verifies with the user's custodian that the user(s) are authorized to execute the requested transaction (which may include balance checks, transfers, etc).
f) The system performs other validity checking on the transaction (such as valid counterparty, reporting requirements under the US Patriot Act, Office of Foreign Access Control (OFAC) sweep, internal risk controls, etc).
g) The transaction is executed in accordance with system procedures and all participating parties (custodians, users, third parties) are notified as required.
h) As required, each participating party confirms their participation in the transaction (e.g. that user accounts may be debited or credited).
i) Custodians may update the central network database as required (new transaction limits, transaction history, etc.)
j) The system maintains a transaction log of all events (both successful and failed)
k) Certain transactions such as transfers require financial settlement. As required the system instructs the custodians or clearing bank to credit or debit the necessary accounts to affect settlement.
l) in certain cases “account settlement” may include pending debits or credits that may be settled with funds sometime in the future. Before cash settlement occurs, each custodian's settlement account may be further debited or credited by various transactions to create a “net settlement” amount to be cleared on the cash settlement date or time.
m) When the transaction is approved, and all custodian accounts are settled (although not necessarily cash settlement), all participating users and custodians are notified by their preferred methods.

### Implementation Details

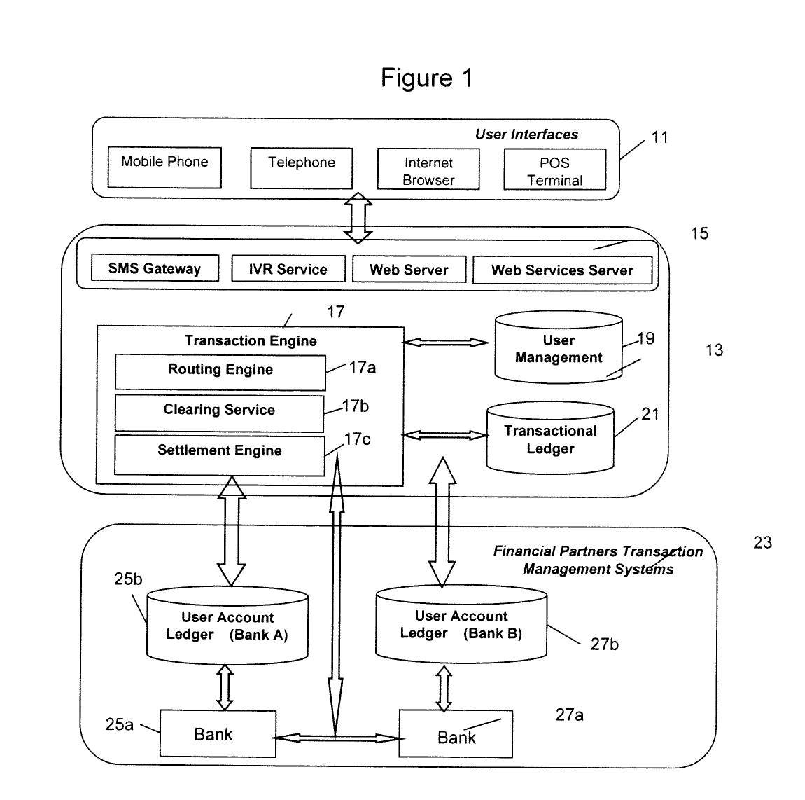

The overall system architecture and transaction flow is shown in FIG. 1.

A user triggers a transaction through a user interface 11 of a user input device such as a mobile phone, land line telephone, Internet browser or Point of Sale (POS) terminal. Such user interface depends on the type of user input device, the details of which are well known in the art and are not needed for a proper understanding of the invention. The transaction is sent to the network operator's transaction management system 13. This central processor includes its own interface 15 which contains sub-interfaces such as an SMS gateway for handling SMS messages sent to and from a mobile phone, an IVR service for handling messages from a land line or mobile phone, a web server for handling messages to and from a web browser and web services server for processing messages to and from a POS terminal. The details of such an interface are well known in the art and are not needed for a proper understanding of the invention.

The appropriate sub-interface of interface 15 receives and decodes the message from the input device and forwards the decoded message to the transaction engine 17. The transaction engine includes a routing engine 17a, clearing engine 17b and settlement engine 17c. The routing engine 17a identifies the appropriate custodians for each side of the transaction based on the sender's and recipient's phone numbers and provides the related secure proxy IDs for each account. The clearing engine 17b formulates the set of instructions to be sent to each participant necessary to conduct the transaction. The settlement engine 17c executes the required transaction commands, and confirms that each command was properly executed by the partner custodian. On successful execution of all steps in the transaction, the system notifies all participants. If an error or violation of system rules should occur (e.g. insufficient funds, closed user account, etc) during any step in the process the transaction is stopped and each party is notified.

The transaction engine uses a standard rule-based system design which is well known to practitioners in the financial transaction field. Each transaction command has a set of required preconditions (e.g. the user must be registered on the system, and have sufficient funds balance), a set of control rules (e.g. the amount a user may transfer may be limited on a daily, weekly and monthly basis), and a set of possible errors and alerts which notify the system and user's when a rule violation has occurred. Each transaction attempt and its outcome is logged in the transaction ledger database with a unique transaction identifier.

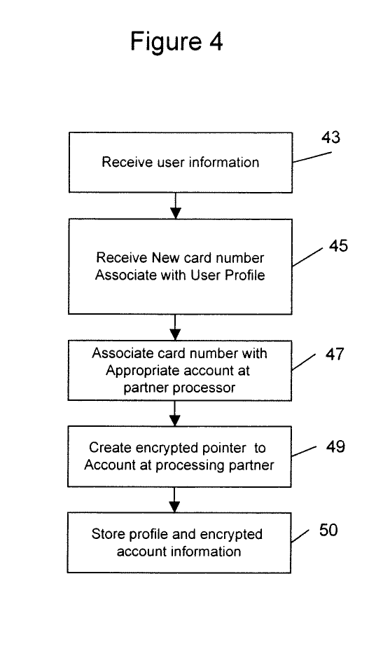

The transaction engine retrieves corresponding account information for transaction participants (sender and recipient) from a user management database 19 which is assumed to already have sender and recipient account information. See FIG. 4 and its accompanying description for an explanation how such account information is obtained and stored. For example, if an SMS message is received which requested that $1,000 be transferred from the sender's account to the recipient's account, the message would contain the following information: recipient's phone number, amount (i.e., $1,000), and potentially a mobile account password (the password may also be communicated in either a separate SMS message, or by a different channel such as IVR). The SMS message is input into the system from the SMS gateway which accepts SMS messages from telecom carriers. The routing engine 17a verifies that both the sender and recipient are properly registered in the system. If the recipient is not yet registered, the system can send the recipient an appropriate message with instructions on how to register. The routing engine identifies the custodian depositories for both the sender and recipient and retrieves the secure proxy identifier numbers for both accounts at each respective custodian.

The clearing engine 17b checks that the transaction conforms to all system rules such as that the sender has sufficient funds on account to cover the transaction inclusive of service fees, that the sender has not reached a predefined transfer limit, and the transfer is allowable for the recipient (e.g. would not put the recipient's account over a maximum storage limit, or exceed the maximum number of allowable transactions in a certain time period).

If the transaction is allowable, the settlement engine prepares the set of instructions necessary to execute the transaction including a debit from the sender's account inclusive of service fees, and a credit to the recipient's account, net of service fees.

The settlement engine 17c executes the transaction by sending the debit and credit instructions to the respective custodians and monitors that each part of the transaction was executed accurately and completely. If an error or transaction exception occurs during the transaction process (e.g. one custodian bank processor is off line or non-responsive) the transaction is stopped and exception protocols are performed (e.g. the system may retry the excepted transaction for a period of time). If all of the steps and rules required for the transaction are completed successfully, the system logs the transaction as complete and notifies both users.

Once the transaction has been completed or fails, the transaction engine records the details of the transaction in a transactional ledger database 21. The specifics of this operation are well known and are not needed for a proper understanding of the invention.

The transaction engine interfaces with each financial partner's transaction management system which are part of financial partners transaction management systems 23. For each bank 25a and 27a involved in the transaction, the system credits and debits the appropriate user account ledgers 25b and 27b respectively involved in the transaction. User account ledgers maintain a user's account balance and transaction history for the user's bank account. Some banks use third party processors to manage user accounts in which case the system will communicate directly with the processor rather than the custodian bank per se.

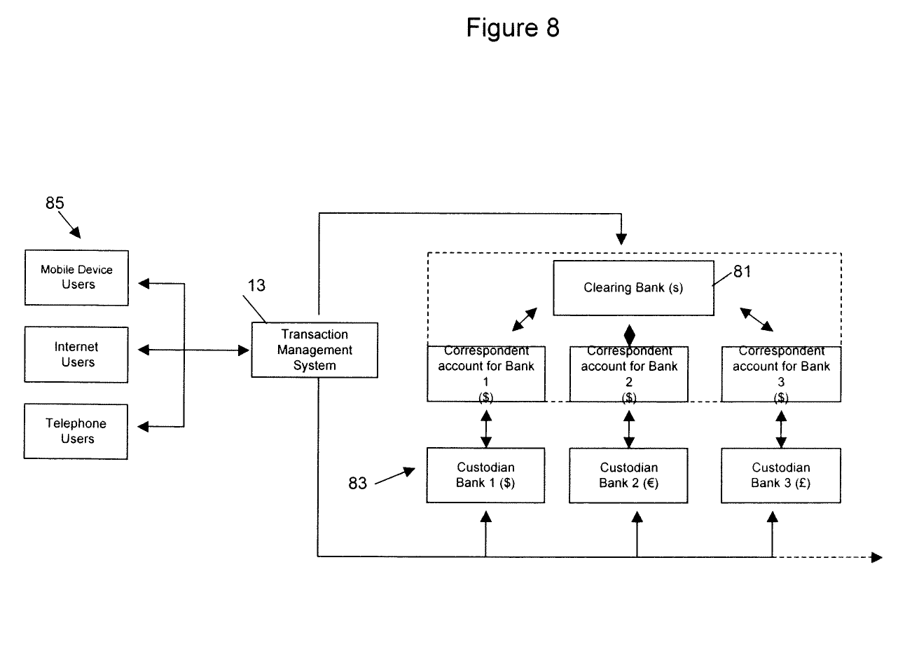

The settlement engine sends settlement instructions to the participating financial institutions 25a and 27a. Specifically, in the case where both custodians have correspondent accounts held at the central clearing bank, the system instructs the central clearing bank to debit the correspondent account of the sender's bank, and credit the correspondent account of the recipient's bank. The system notifies both banks, or their processors, to update the accounts of their respective users. Note that in this case, no funds were moved into or out of either custodian bank or the central clearing bank. Only the ownership of the appropriate funds held in the correspondent accounts was changed with accounting entries. Further details regarding this aspect of the invention are described below with reference to FIG. 8.

In certain cases the correspondent account method cannot be used, such as in the cases where one or both of the participating banks do not have a correspondent account held at the central clearing bank. In these cases once the settlement instructions have been received, the financial institutions 25a and 27b must settle the transaction directly between themselves using traditional inter-bank settlement methods (e.g. ACH, SWIFT, CHAPS, etc).

In these cases the recipient's bank can choose to extend immediate credit to the recipient in advance of final settlement from the sender's bank or wait until final settlement has been received from the sender's bank. In either case the recipient's bank will notify the system operator via a secure connection when the recipient's account has been credited and the system operator will then notify the user that the funds are available for use.

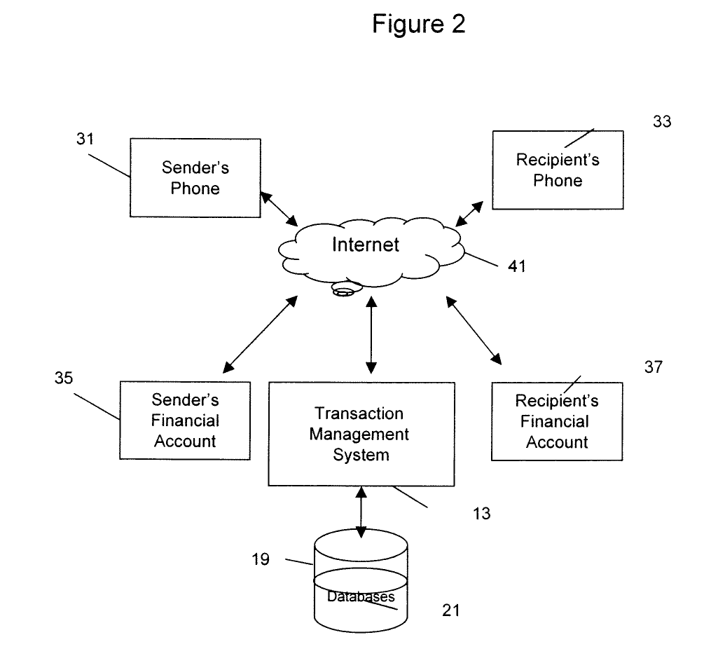

The invented system is primarily designed to support person-to-person transfers of funds (or other valuables) using mobile phones. Referring now to FIG. 2, the system includes the following components:
The sender's phone 31 is enabled to send and receive SMS, WAP or application messages (or voice). The recipient's phone 33 is similarly enabled.
The sender's financial account 35 from which the transferred assets are maintained which may be a prepaid card, or bank account, etc. The recipient's financial account 37 is the account into which the transferred value is to be deposited. These two accounts correspond to user account ledgers 25b and 27b shown in FIG. 1.
All communication is routed through secure internet connections 41.

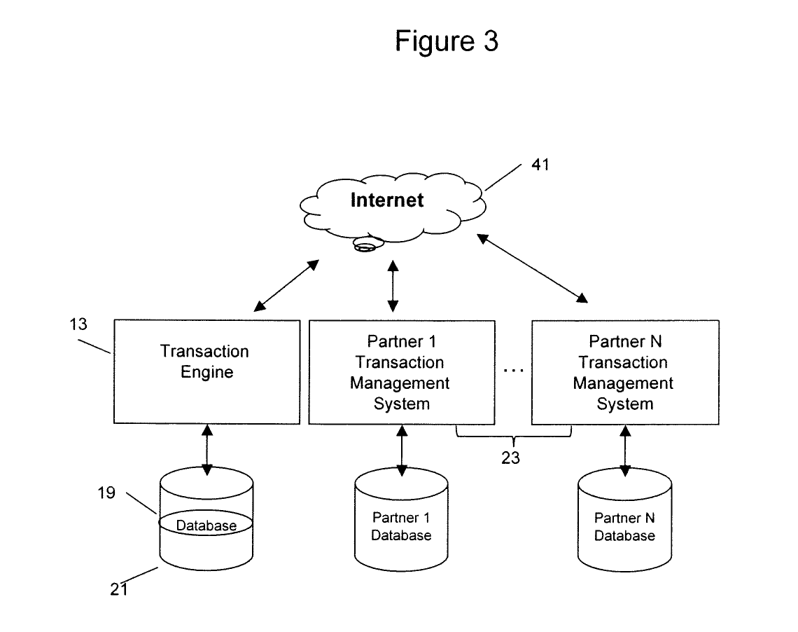

Referring to FIG. 3, the network routing will now be described.

The central transaction management system 13 connects to corresponding processing elements in partner banks or the like using a secure connection via the Internet 41.

The system can support multiple (N) partners, each of which has its own transaction management system within Financial Partners Transaction Management system 23. Each partner's transaction management system maintains a user account ledger of the type shown in FIG. 1 and may be accessed through central clearing bank correspondent account.

FIG. 4 describes how a new user is registered on the network operator's system. The network system receives new user information 43 either from a live operator or in a batch file from a partner as described above with reference to FIG. 1. This information is stored in a secure database such as 19.

The user provides a bank account or card number (or other financial account number) which is received 45 and associated 47 with the user's profile including phone number in the user management database 19.

The user management database 19 associates 47 the user's phone number with a secure proxy pointer 49 to the user's account held at the user's financial institution.

The transaction management system 13 then stores 50 the user profile, and secure account link in secure user management database, 19.

When the user requests a transaction, the system looks up the user's profile and communicates with his custodian institution using the secure proxy pointer in order to access the user's account information.

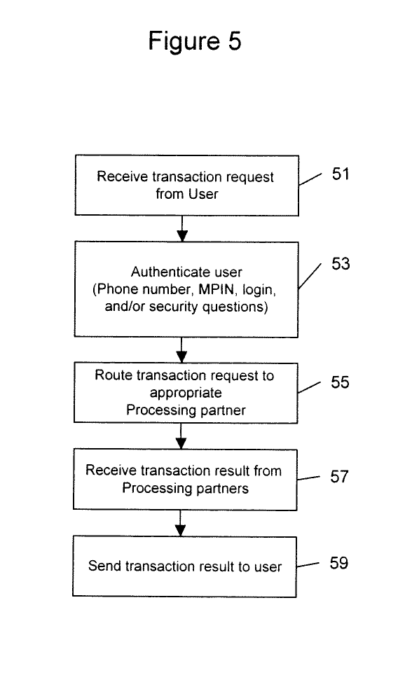

A transaction processing description will now be provided with reference to FIG. 5.

The invented system receives 51 a request from the user to perform a specific transaction (e.g. balance request, funds transfer, purchase, loan request, etc.)

The user may communicate with the system through a number of channels including Web, WAP, SMS, J2ME phone application, IVR or live operator as explained above with reference to FIG. 1.

The system authenticates 53 the user with at least two forms of identification such as phone number, mobile phone PIN (MPIN), login with password, or security questions, depending on the communication channel.

The transaction request is routed 55 to the appropriate processing partner based on a user/processor table stored in the user management database 19.

The system receives 57 the result from the appropriate processing partner after the processing partner executes the transaction. For example, to execute a balance request the system receives the request from the user and routes a properly formatted balance request based on the connection protocol to the user's bank. The user's bank replies to the network request with the user's balance. The result is sent 59 back to the user using the appropriate communication channel based on how the transaction was initiated in step 51.

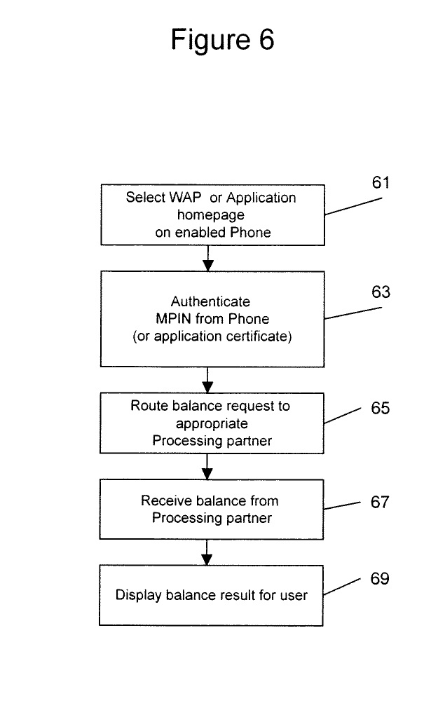

An application/WAP example will now be described with reference to FIG. 6.

This example shows how a user can retrieve a real time account balance from their phone. In this example the user may use either WAP or a phone resident application (e.g. J2ME, BREW, etc).

The user starts the process by selecting 61 the home page of the network operator on either the WAP internet, or the application and entering login credentials such as their user name or phone number and Mobile Personal Identification Number (MPIN).

The system authenticates 63 the user and routes 65 the transaction to the user's financial institution via a secure internet connection.

When the system receives 67 the balance from the user's bank, it is displayed 69 to the user.

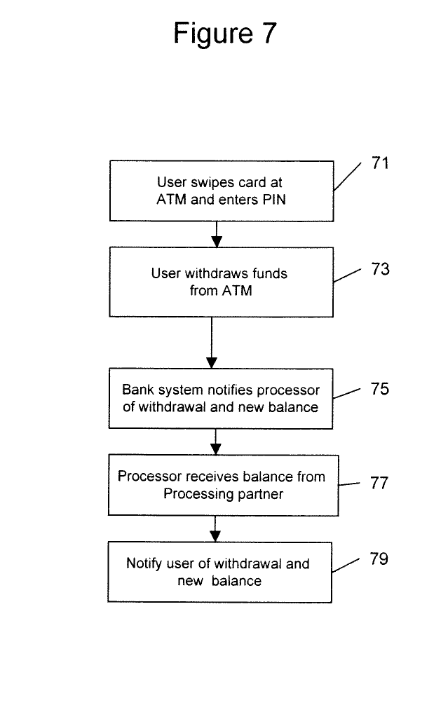

A balance change notification example will now be described with reference to FIG. 7.

The user swipes an ATM card and enters a PIN 71 so that the user can withdraw 73 funds from the ATM.

The financial institution processes the withdrawal and notifies 75 the system about the transaction and the user's new balance. In certain cases the system may periodically query the bank to identify any new transactions.

The system receives the notification 77 and notifies 79 the user using a preferred communication channel such as SMS.

FIG. 8 illustrates the invented mobile transaction network using a clearing bank model wherein the transaction management system 13 connects thorough a central clearing bank or banks 81.

Transaction management system 13 must communicate with all parties in the transaction—the clearing bank 81, the custodian banks 83, and the sender and recipient represented by users 85 in order to control both the funds and information flows, and mostly to provide immediate access (notification) to the funds for the recipient. This hub-and-spoke model eliminates the time delay otherwise created by node-to-node propagation.

When settlement engine 17c (shown in FIG. 1) instructs clearing bank 81 to debit one custodian bank and credit the other—the results of that transaction are known only to the clearing bank. The system provides the real time notification to the custodian banks 83 that their accounts at the clearing bank have been updated.

Without the invented system, in order for both of the custodian banks to be notified that their holding accounts in the clearing bank 81 have been adjusted in real time, they would both have to build a direct technical connection to the accounting system at the clearing bank. This would require that every custodian bank have a direct connection to the clearing bank.

Banks do not want to build or manage this type of system—so the invented system provides this unique integration to each custodian bank using whatever standards, API, or the like each bank has. The system provides a missing intelligent interlingua layer that supports the required communications among multiple system types.

Currently, banks are connected to one another via the ACH service managed by the Federal Reserve. The ACH provides funds notice and settlement together at T+1 (or sometimes T+2) where T represents the day on which the transaction is initiated, but does not operate on the weekends or during national holidays. So the ACH cannot be used to provide instant, guaranteed transaction settlement (24×7×365).

The invented system separates the notification and settlement functions. In one embodiment of the system, the custodian banks place good funds with the clearing bank ahead of the transaction. So, in a sense, the transaction is “pre-settled” assuming that there are sufficient funds on deposit to cover the proposed transaction.

In another embodiment of the system, the network operator places it own capital with the custodian banks for the same reasons—to provide good funds to allow instant guaranteed transactions. The recipient's custodian bank's accounting system can now credit the recipient's card or bank account in real time—even though the original funds are still physically located at the originating custodian bank. The sender's custodian bank executes an internal transaction to debit the sender's account and credit the network operator's correspondent account. Likewise, the recipient's custodian bank executes an internal transaction to debit the network provider's correspondent account and credit the recipient's account. Both custodian banks notify the system when the transactions are complete.

The system then notifies the users in real time. Without this system, the banks would have to have special systems in place to provide this capability.

The system uses industry standardized processes (secure host-to-host integrations) to build the missing network needed to support real time transactions. The system also uses specifically designed software to provide three unique features:
1) A real time notification system between participants in the network.
2) A standardized way to identify users across custodians based on their phone number. The central database holds Know Your Customer (KYC) information on users which custodians need to conduct international transactions.
3) An “open” platform that allows non-bank custodians and other entities to have controlled interaction with the other network participants.

Typical bank systems (ACH, SWIFT, etc) are for banks only and do not allow other entities to interact—at least not easily. This open architecture gives the network participants new power and flexibility that is not possible, desirable, or allowable with existing systems.

The invented system, which uses a standardized way to identify users across banks based on their phone numbers, and provides the necessary open platform, is implemented as follows. The system uses direct real-time messaging between the transaction engine and the partner custodian's systems. Such messaging is typically conducted using either the ISO 8583 inter-bank protocol or “Web Services.” Web service is defined by the W3C as “a software system designed to support interoperable machine-to-machine interaction over a network.” Web services may include Web based APIs (Application Programming Interface) that can be accessed over the Internet.

The transaction engine maintains a table comprised of entries for the user's phone number and entries for a pointer to the user's bank account information. This allows the system to identify a user and route transactions to the user's custodian bank as described above. The system provides an open platform for multiple partners to interact with the system by allowing access to its core functionality through web services, which can be invoked by any partner wishing to access the network's capabilities.

By utilizing the present invention, merchants could integrate their POS (Point of Sale) systems directly into the network to allow real time payment by phone. Merchants could also have good funds on account to provide instant refunds to anyone who pays by phone or uses a certain coupon.

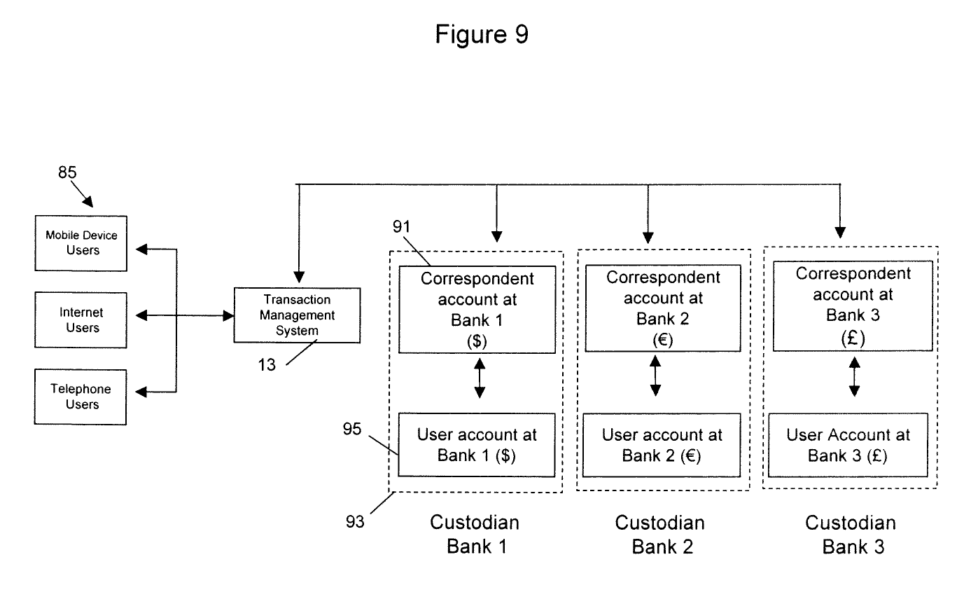

FIG. 9 illustrates an alternate embodiment of the mobile transaction network in which funds are held in a correspondent account 91 at each of the custodian banks in the network that do not have accounts at a central clearing bank. The custodian banks 93 can move funds from the correspondent accounts to and from the user accounts 95 with an internal “on us” transaction, which provides for an instant and guaranteed transfer of good funds. In this embodiment, “instant” means as fast as the custodian bank can process the transaction.

1. A system for transferring assets from an account held at a first institution to an account held at a second institution based on instructions entered using a user access point, said system comprising:
a) a transaction manager including an interface, a transaction engine, a user management database, and a transactional ledger database;
b) wherein said interface receives and decodes transaction messages from the user access point and forwards decoded messages to the transaction engine, said transaction messages including a transaction and at least sender and recipient account information, said information including sender and recipient phone numbers or proxies thereof;
c) wherein the transaction engine includes a routing engine, a clearing engine and a settlement engine;
d) wherein the routing engine identifies custodians for each side of the transaction based on the sender and recipient phone numbers and provides related secure proxy IDs for each account by accessing corresponding account information for the sender and recipient from the user management database;
e) wherein the clearing engine generates a set of transaction commands for sending to each partner custodian necessary to conduct the transaction;
f) wherein the settlement engine receives the transaction commands, sends the transaction commands to each said necessary partner custodian and confirms that each command was properly executed by each said partner custodian, and if the transaction is allowable based on said confirmation, the settlement engine prepares a set of instructions which are sent to each partner custodian to execute the transaction including a debit from the sender's account, and a credit to the recipient's account, said debits from said sender's account and said credits to said recipient's account occurring substantially in real time.

2. The system defined by claim 1 wherein said transaction engine maintains a table comprised of entries for the sender and recipient phone number and entries for a pointer to the sender and recipient account information.

3. The system defined by claim 1 wherein direct real-time messaging is utilized between the settlement engine and each of said partner custodians.

4. A method for transferring assets from an account held at a first institution to an account held at a second institution based on instructions entered using a user access point, said method comprising:
a) receiving and decoding transaction messages from a user access point and forwarding decoded messages to a transaction engine, said transaction messages including a transaction and at least sender and recipient account information, said information including sender and recipient phone numbers;
b) identifying custodians for each side of the transaction based on the sender and recipient phone numbers and providing related secure proxy IDs for each account by accessing corresponding account information for the sender and recipient from a user management database;
c) generating a set of transaction commands for sending to each partner custodian necessary to conduct the transaction;
d) receiving the transaction commands, sending the transaction commands to each said necessary partner custodian and confirming that each command was properly executed by each said partner custodian, and if the transaction is allowable based on said confirmation, preparing a set of instructions which are sent to each partner custodian to execute the transaction including a debit from the sender's account, and a credit to the recipient's account, said debits from said sender's account and said credits to said recipient's account occurring substantially in real time.

5. The method defined by claim 4 wherein said receiving and decoding operates by maintaining a table comprised of entries for the sender and recipient phone number and entries for a pointer to the sender and recipient account information.

6. The method defined by claim 4 wherein receiving the transaction commands and sending the transaction commands utilizes direct real-time messaging to and from each of said partner custodians.
